(19) United States
(12) Patent Application Publication
(10) Pub. No.: US 2006/0036567 A1
(43) Pub. Date: Feb. 16, 2006

(54) Method and apparatus for organizing searches and controlling presentation of search results

(76) Inventor: Cheng-Yew Tan, Cupertino, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/917,874

(22) Filed: Aug. 12, 2004

(51) Int. Cl. G06F 17/30

(52) U.S. Cl. 707/1

(57) ABSTRACT

Method and apparatus for organizing searches and controlling the presentation of search results are described herein. A hierarchical search structure provides search storage for replay. Search results can be aggregated through search groups, to collect and present related items from multiple searches together, and search result layout can be specified through search pages, which are an added level to the hierarchy. It is suited for sites like eBay, where the search environment is noisy and search repetition is desirable. Other methods and apparatuses are also described.

### COPYRIGHT NOTICES

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to a computer system. More particularly, this invention relates to organizing searches and controlling presentation of search results.

### BACKGROUND OF THE INVENTION

The popularity of auctions has grown dramatically in recent years. This growth has made a great diversity of items available online. Auctions sites like eBay allow sellers to make up the titles and descriptions of listings, which are then indexed for searching.

Often there is great variation in how items are titled and described. Different sellers may describe the same item differently. Synonyms and abbreviations may be used and words may be spelled differently, or even misspelled. Other types of variation include the use of different, but equivalent size systems (e.g. “40 Regular” or “Euro 50”), and the way equivalent measures may be written (e.g. “half”, “0.5”, or “½”). Parts may also be listed as working for only a subset of the items that they are capable of working with (e.g. a docking station that's listed for a Dell Inspiron D800 may also happen to work for the Inspiron 8500 and 8600 models), and in some cases, the sellers may not know what the items are, or how best to describe them.

Some sellers, for their part, are motivated to increase the probability of buyers finding their items. They may use multiple synonyms, abbreviations, and variations as listed above in their titles and descriptions to facilitate and increase the probability of their items showing up in a search. For example, a computer hard drive tray may also be listed as a caddy, carrier, cart, holder, or mount. Some sellers may also choose to mention the other unrelated items that they have listed for auction in their desire to increase traffic and the chances of discovery.

A buyer using such systems in the prior art conducts searches in a noisy environment. It often pays to be creative while searching though. It is advantageous to incorporate synonyms, abbreviations, and other variations in the search queries as they may lead to auctions that few others will find, resulting in purchases of products below prevailing market rates. However, such creative searching also incurs a price in the large number of irrelevant items that are returned. Therefore to search efficiently, the buyer has to balance search terms that are inclusionary for wide coverage (i.e. A OR B OR C), and search terms that are exclusionary (i.e. AND NOT (X OR Y OR Z)) in order to cut down on the noise. It is not uncommon that long and even multiple search queries are made for the same item.

In the prior art, users are taught an unstructured and flat user-interface. Users are typically presented with a text box for entering a search query and a submit button which returns a set of results for each search query. The length of the search query is often limited to some maximum, and when this limit is hit, compromises are necessary as the goals for inclusion and exclusion are conflicting. Querying for more items or more variants reduces the query room for specificity, and being specific reduces the query room for more items. If a search query has to be shorter than what's desired, the buyer may miss out on items, or else they will have to put up with more noise; and if multiple searches are made, a buyer would likely have to wade through duplicates of items that show up in the different sets of search results as a result of the motivation of the sellers and their tactics as described above.

Flat interfaces also suffer from the inability to relate multiple searches when a combination of the search results from multiple searches is desired. In the prior art, searches can be restricted by specifying some attribute including geographic location and currency. If a buyer wishes to search an area that spans several regions, they have no choice but to make multiple searches. Also, if a buyer wishes to search for several alternative items, they may need to make multiple searches to accomplish their goal, and it often becomes difficult to keep track of items across multiple sets of search results.

Also in the prior art, auction durations are typically short, and last in the order of several days, with new items being made available constantly. As a result, collectors and bargain hunters commonly repeat the same searches so as not to miss out.

Flat and unstructured searches work well when the items that are sought are predictably indexed, and when there is not much desire to make the same searches repeatedly. They are standard for sites like Amazon.com and Buy.com. For sites such as eBay, the flat interface is not ideal. Lengthy and multiple searches, along with repetition of the searches, are sources of tedium, and an improved search interface is desirable.

### SUMMARY OF THE INVENTION

Method and apparatus for organizing searches and controlling the presentation of search results are described herein. A hierarchical search structure provides search storage for replay. Search results can be aggregated through search groups, to collect and present related items from multiple searches together, and search result layout can be specified through search pages, which are an added level to the hierarchy. It is suited for sites like eBay, where the search environment is noisy and search repetition is desirable. Other features of the present invention will be apparent from the accompanying drawings and from the detailed description which follows.

### BRIEF DESCRIPTION OF THE DRAWINGS

The present invention is illustrated by way of example and not limitation in the figures of the accompanying drawings in which like references indicate similar elements.

FIG. 1 is a diagram illustrating an exemplary graphical user interface (GUI) for conducting searches and presenting search results, according to one embodiment of the invention.

FIG. 2 is a diagram summarizing the organization of the search tree and the search results, according to one embodiment of the invention.

FIG. 3 is a diagram illustrating an exemplary GUI of a user-interface for creating a search page, according to one embodiment of the invention.

FIG. 4 is a diagram illustrating an exemplary GUI of a user-interface for creating a search group according to one embodiment of the invention.

FIGS. 5A-5D are diagrams illustrating exemplary GUIs for creating searches according to one embodiment of the invention.

FIG. 6 is a diagram illustrating an exemplary GUI of a user-interface representation of a search tree according to one embodiment of the invention.

FIGS. 7A-7B are diagrams illustrating exemplary GUIs that allow a user to initiate search updates, and create the search tree elements according to one embodiment of the invention.

FIG. 8 is a diagram illustrating an exemplary GUI for displaying search results according to one embodiment of the invention.

FIG. 9 is a flow diagram illustrating an exemplary process for creating a search tree according to one embodiment of the invention.

FIG. 10 is a diagram of a network of computer systems which may be used with one embodiment of the invention.

FIG. 11 is a block diagram of a digital processing system which may be used embodiment of the invention.

### DETAILED DESCRIPTION

Method and apparatus for organizing searches and controlling the presentation of search results are described herein. In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), erasable programmable ROMs (EPROMs), electrically erasable programmable ROMs (EEPROMs), magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

Embodiments of the invention relate to searching in a computer environment, where a search query returns search results which are a set of zero or more items. In the examples, we will use auction listings as the items that are returned from the search queries.

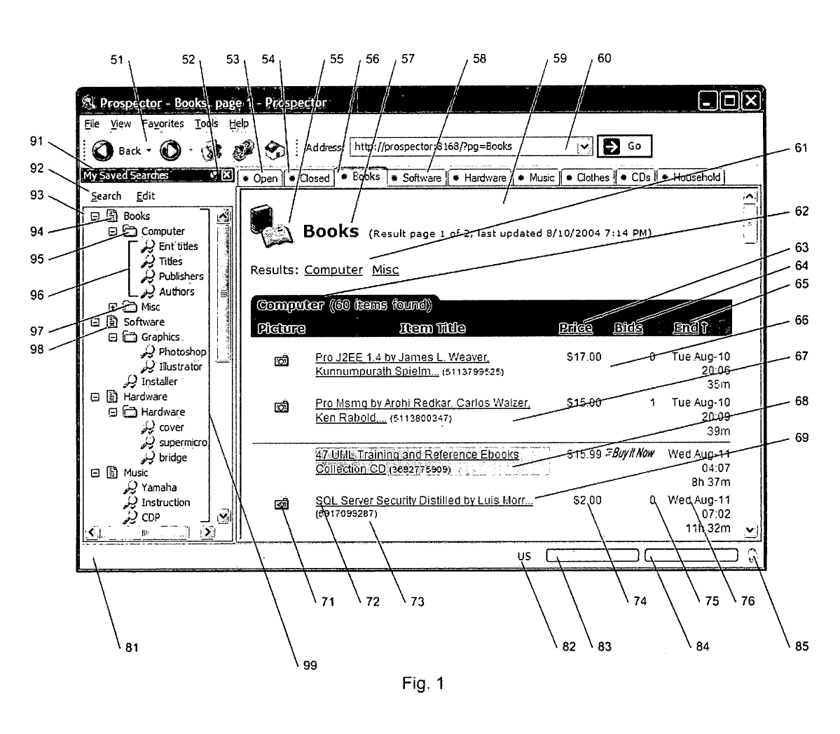

FIG. 1 is a diagram illustrating an exemplary graphical user interface (GUI) for conducting searches and presenting search results, according to one embodiment of the invention. Referring to FIG. 1, the exemplary GUI is presented by way of an example as a screenshot. In one embodiment, the application may be specialized for searching items in an eCommerce site, such as, for example, eBay. In one embodiment, the exemplary GUI includes, but is not limited to, a toolbar 91 to allow a user to save a searches created by the user. The toolbar 91 may include a window 93 which displays the user-interface representation, such as, for example, search hierarchical structure, according to certain embodiments. This hierarchical structure is the search tree 99 that the user builds to organize and save searches for replay. In this example, the user makes use of menu 92 to build and manipulate the search tree 99.

In one embodiment, the search tree 99 may include one or more search pages. Each search page may include one or more search groups and/or one or more individual searches. Each search group may include one or more individual searches. In this example, the search tree 99 includes search pages 94 and 98. The exemplary GUI allows searches and search groups to be attached as children to search pages, through, for example, a drag and drop operation. A search may be used to store a search query and a search group may be used to group one or more searches. In this example, search page “Books” 94 is the parent of two search groups, “Computer” 95, and “Misc” 97. Search group “Computer” 95 is in turn a parent of four individual searches 96.

The stored searches may be subsequently replayed. According to one embodiment, menu 92 contains an option to initiate a search update on a search page. A search update is an event that is propagated down the hierarchy. In response to the search update event, search pages and search groups initiate search updates for their respective children. In response to a search update event, each individual search retrieves the stored search query, replays the search query, and retrieves the search results. Further detailed information regarding menu 92 will be described further below.

A search group, on completion of a search update, creates a union of the search results retrieved by its children. A search page, on completion of a search update, orders the search results of its children to match their order in the search tree. A user is thus able to save and organize their search queries through searches and search groups, and control the presentation of search results with search pages.

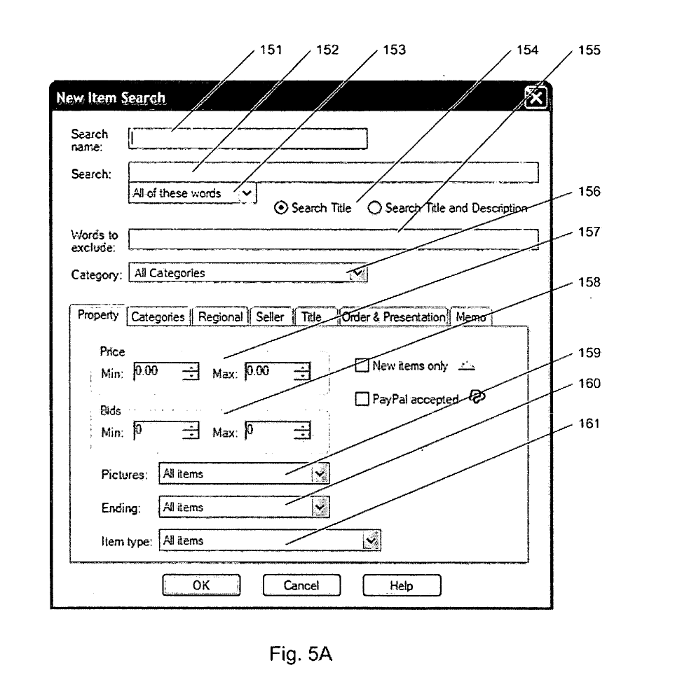

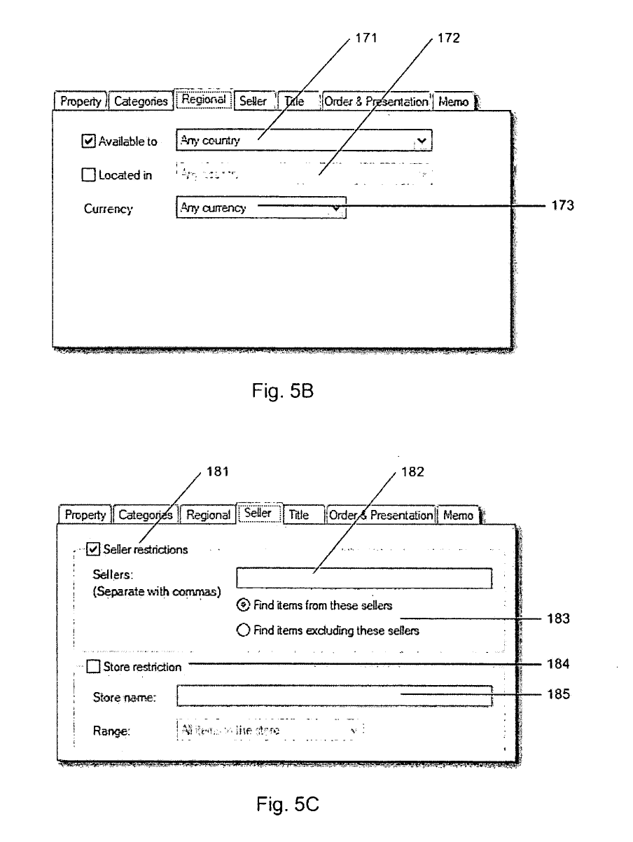

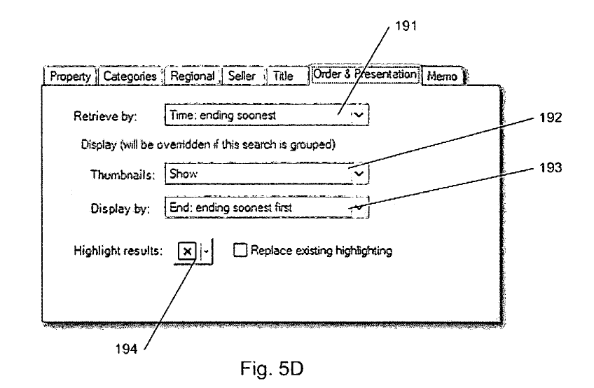

According to one embodiment, the exemplary GUI also allows a user to attach attributes and restrictions to a node in the search tree to help with searching. For example, as illustrated in FIG. 5D, a user can attach a highlighting attribute to an individual search to have it mark its search results with a chosen color to get them to stand out. As another example, the user can attach a maximum price as a restriction to a search group. The search group can then apply this filter after it creates the union of the search results as part of its search update processing.

To display the search results, according to one embodiment, a tabbed page, each containing an instance of a web browser is created for every search page that the user creates. In this example, the tabbed page “Books” 56 corresponds to search page “Books” 94, and the tabbed page “Software” 58 corresponds to search page “Software” 98. Since the tabbed page window contains a web browser, standard web browser navigational controls are provided. These controls include the navigational toolbar buttons 51, the Internet address text box 60, the status bar 81, the download progress bar 84, and the security icon 85.

In one embodiment, label 82 shows the international website, such as the eBay U.S. site that the application searches. Progress bar 83 shows the progress while a search update is in progress. The toolbar 91 can be minimized or dismissed with the controls 52. The “Open” and “Closed” tabs 53 and 54 are tabbed pages for watch lists that the user uses to place items of interest. Specifically, the “Open” page (53) shows watched items that are still active, while the “Closed” page (54) shows watched items whose auctions have ended.

As for the search results, according to one embodiment, the search page displays an icon 55 that the user attaches as an attribute to the search page, followed by the name of the page 57. This is followed by hypertext links 61 to the search results of the search page's children. The search results are then presented to match the order of the search page's children in the search tree. In the example, search group “Computer” 95 is the first child, and its results (62) are listed before the search results of search group “Misc” 97. Items 66-69 are individual items found through searching, and they are a subset of the union of the search results of the four individual searches 96. Each search result item has attributes such as, for example, picture presence 71, item title 72, listing number 73, current price 74, number of bids 75, and/or end time 76.

The display of each of the search page's children can be delineated with a header 62 that includes information about the search results, as well as hypertext links 63-65 to let the user change the sort order of search results. In this example, the up-arrow next to the “End” link 65 indicates that the search results are currently sorted by ascending end time. Clicking on link 65 will toggle the sort order between descending and ascending, and similar behavior exists with links “Price” 63 and “Bids” 64.

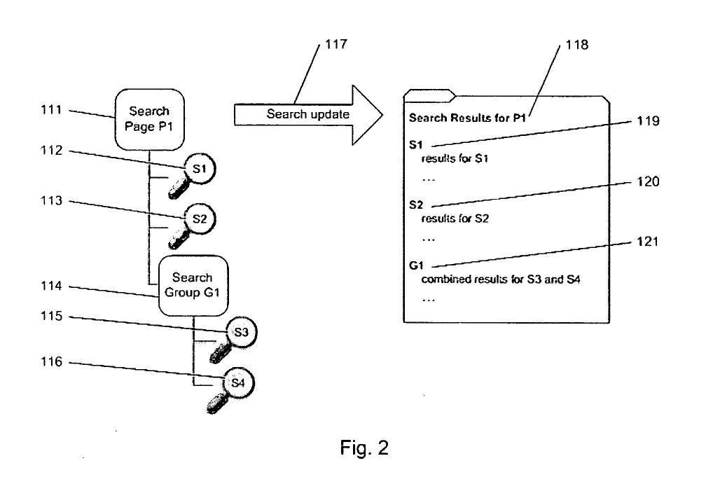

FIG. 2 is a diagram summarizing the organization of the search tree and the search results, according to one embodiment of the invention. Referring to FIG. 2, a search page can be a parent to searches and/or search groups. In this example, search page “P1” 111 has three children, searches “S1” 112 and “S2” 113, and search group “G1” 114. A search group can be a parent to searches, and in this example, search group “G1” 114 is parent to searches “S3” 115, and “S4” 116.

When a search update is performed on a search page, the search results will be laid out to match the order of the children. In the example, the order of the search results 119-121 match the order of the children 112-114. A search group's search results are the union of the search results of its children.

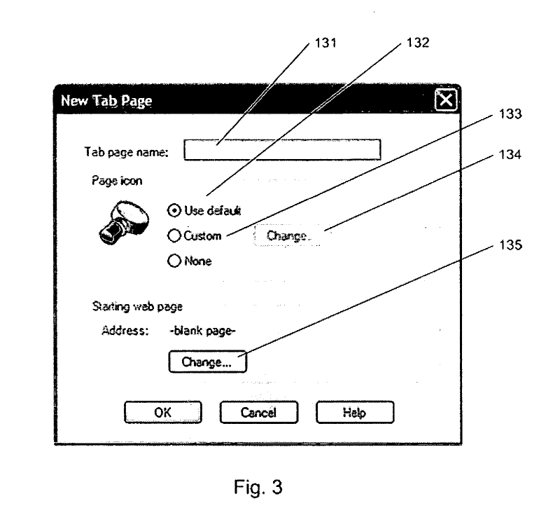

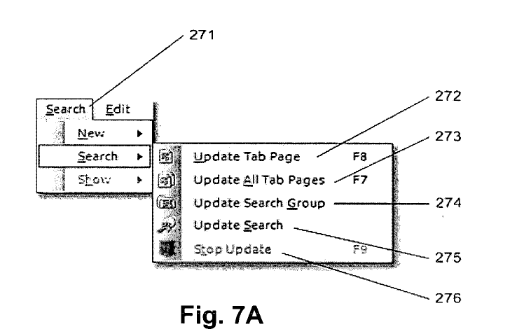

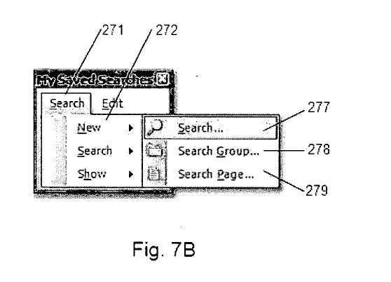

The user builds the search tree from the top down. If search pages are incorporated, the user starts by creating a search page. FIG. 3 is a diagram illustrating an exemplary GUI of a user-interface for creating a search page, according to one embodiment of the invention. The exemplary GUI of FIG. 3 may be initiated from menu 92 of FIG. 1 and/or from the exemplary GUI shown in FIG. 7B. Referring to FIG. 3, the name of the search page is entered in text box 131. An icon that is used to dress the search page when it is displayed is attached as an attribute of the search page and it is chosen through list 132. The icon can be changed from its default by selecting Custom 133 which will then enable the Change button 134, which in turn, if clicked, will bring up an icon selector. This embodiment creates a web browser for each search page, so a starting web page can be attached as another attribute by clicking on 135 and specifying an Internet address.

The user attaches a search group to a search page by selecting the search page in the search tree. In the case of a search tree 99 as depicted in FIG. 1, the standard means of selecting the search page is by clicking on the search page with a computer mouse. The computer system will highlight the selected node in the tree, and it becomes the target of operations.

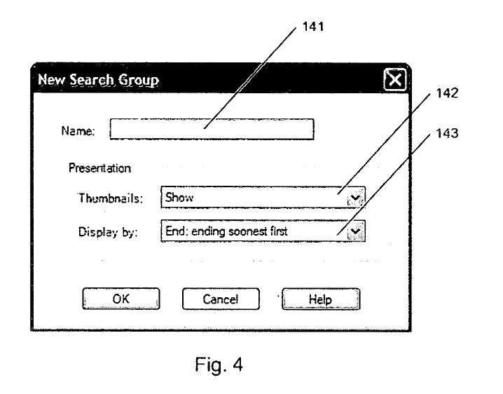

FIG. 4 is a diagram illustrating an exemplary GUI of a user-interface for creating a search group according to one embodiment of the invention. The exemplary GUI of FIG. 4 may be initiated from menu 92 of FIG. 1 and/or from the exemplary GUI shown in FIG. 7B. Referring to FIG. 4, the name of the search group may be entered in field 141. Whether the search results should display thumbnail images is attached to the search group as a restriction through list 142. The other options are “Don't Show”, and “Show thumbnails as Picture icons”. This last option is provided to let users speed up their searching by not having to download photo images. Separately, the initial sort order of the search results is attached through list 143. The user can choose to sort by the number of bids, the price, the start, and the end time, ascending or descending.

FIGS. 5A-5D are diagrams illustrating exemplary GUIs for managing searches and results according to one embodiment of the invention. The exemplary GUI of FIG. 5A may be initiated from menu 92 of FIG. 1 and/or from the exemplary GUI shown in FIG. 7B. Referring to FIG. 5A, the exemplary GUI allows the user to save a search query, and to attach attributes to the search, and restrictions to the search results. The search query is entered in text box 152. The type and scope of the search query are controlled by list 153, choices 154, text box 155, and list 156. A name to represent the search is entered in text box 151. Restrictions can be placed on the search results by price 157, number of bids 158, picture presence 159, ending time 160, and item type 161.

Referring to FIG. 5B, according to one embodiment, an example of regional restrictions that can be attached to the search results is illustrated. For example, a user can choose via field 171 to specify the country for which that the sought for items are available. Field 172 may be used to specify where the sought items are located. The currency that the sought items are denominated in is entered in field 173.

Referring to FIG. 5C, according to another embodiment, an example of seller restrictions that can be attached to the search results is illustrated. For example, a user can choose to specify seller restrictions via field 181, and store restrictions via field 184. For seller restrictions, the user can specify one or more sellers via field 182, and choose between having the search results limited to these sellers, and having the search results limited to those that are not sold by these sellers via field 183. Some Web sites, such as eBay, let users operate stores, which are separate from auctions, and restrictions can be set for store names as well via field 185.

With respect to FIG. 5D, according to a further embodiment, examples of additional search attributes that can be attached to the search are illustrated. For example, a user can choose to specify the sort order of the search results via field 191, whether to display images via field 192, the sort order when the search results are displayed via field 193, and how the search results should be highlighted via field 194. Highlighting is useful to get search results to stand out. For example, a user can set up a search for a rare item to have it highlight its search results. When the rare item turns up, it will then stand out (e.g., having a different colored background than other non-highlighted items).

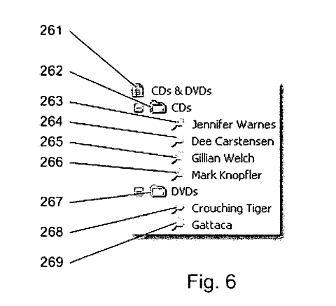

FIG. 6 is a diagram illustrating an exemplary GUI of a user-interface representation of a search tree according to one embodiment of the invention. For example, the exemplary GUI of FIG. 6 may be a part of the exemplary GUI shown in FIG. 1. Referring to FIG. 6, according to one embodiment, a search tree element is represented by an icon and the element's name. In this example, there is a search page 261. The hierarchical structure is represented by indenting the contained search groups and searches. This search page contains two search groups named “CDs” 262, and “DVDs” 267. Search group “CDs” 262 contains four individual searches 263-266. Search group “DVDs” contains two individual searches 268-269. This hierarchical structure is referred to as a search tree. A search tree may contain one or more search pages, each of which may contain one or more search groups and searches, and each search group may contain one or more searches. The structure of this search tree is mirrored in computer storage (e.g., data structures) as it stores the user's set of search queries, as well as how the user wants to see the search results.

FIGS. 7A-7B are diagrams illustrating exemplary GUIs that allow a user to initiate search updates and create search tree elements according to one embodiment of the invention. The exemplary GUI of FIGS. 7A-7B may be initiated from the exemplary GUI shown in FIG. 1, for example, clicking menu item 92 of FIG. 1.

Referring to FIG. 7A, according to one embodiment, a search update may be initiated by first selecting a node in the hierarchy (e.g., clicking one of the nodes from the exemplary GUI of FIG. 6), and then selecting a menu option from menu 271. Here, a search is selected, and the user can choose to initiate a search update on the search page to which the search belongs 272, on all search pages 273, on the search group to which the search belongs 274, or on the search itself 275. If a search update is in progress, it will be an option to stop the search update through 276.

Referring to FIG. 7B, a new search tree element may be created via the “New” submenu. Submenu item 277 is used to create an individual search, which when selected, a new search GUI, similar to the one shown in FIG. 5A is displayed.

The submenu item 278 is used to create a search group. When the submenu item 278 is selected, a search group configuration GUI, similar to the exemplary GUI shown in FIG. 4, may be displayed.

The submenu item 279 may be used to create a search page. When the submenu item 279 is selected, a search page configuration GUI, similar to the exemplary GUI shown in FIG. 3, may be displayed.

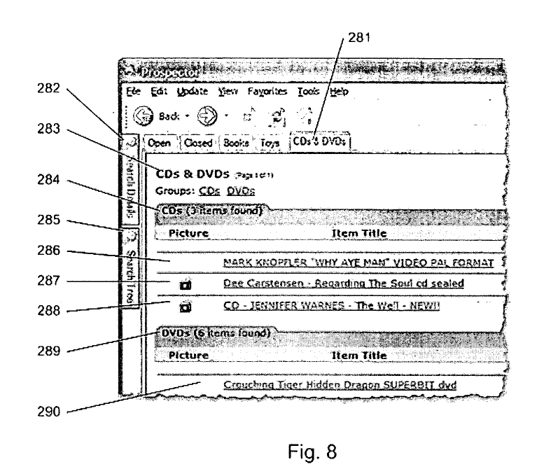

FIG. 8 is a diagram illustrating an exemplary GUI for displaying search results according to one embodiment of the invention. Referring to FIG. 8, tabbed pages are created to correspond with the search pages in the search tree. This example illustrates the layout and ordering of the search results after a search update is performed on the search tree represented by FIG. 6. The tab page 281 is given the name of the search page 261 in FIG. 6. The name of the search page is repeated in the title 283.

In one embodiment, the search results are presented in the order specified in the search tree. For example, the search results for search group “CDs” 284 is presented before the search results from search group “DVDs” 289. This order corresponds to search groups 262 and 267 in FIG. 6.

In one embodiment, the search results of a search group are the union of the search results of the contained searches. For example, search results 286-288 are the union of the search results gotten by replaying the searches 263-266 in FIG. 6. Likewise, the search result 290 is the union of the search results gotten by replaying searches 268-269 in FIG. 6. Buttons 282 and 285 may be used to minimize toolbar windows, in particular, to minimize the search tree window 91 shown in FIG. 1.

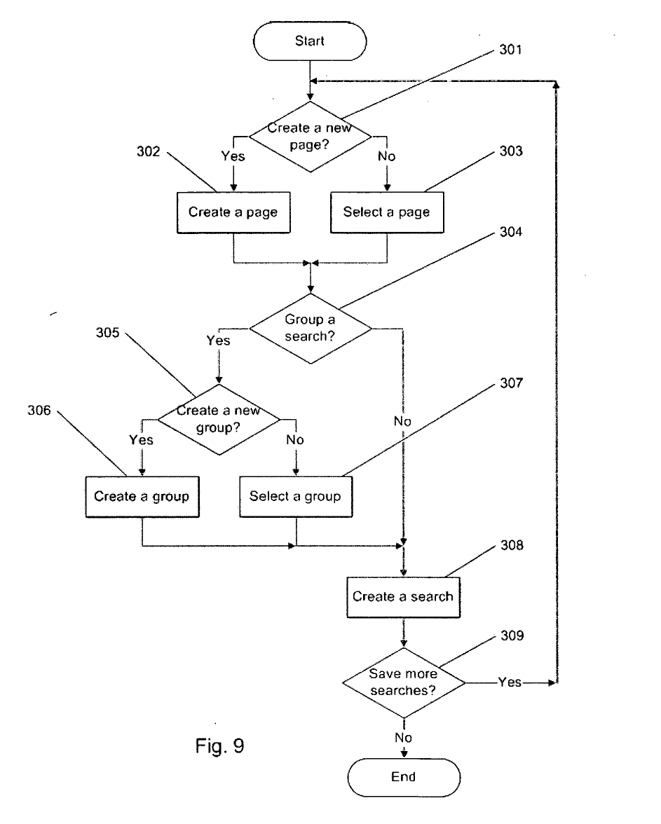

FIG. 9 is a flow diagram illustrating an exemplary process for processing a search according to one embodiment of the invention. The exemplary process may be performed by a processing logic that may comprise hardware (circuitry, dedicated logic, etc.), software (such as is run on a dedicated machine), or a combination of both. In one embodiment, an exemplary process includes, but is not limited to, creating a search group, the search group including one or more searches that are different from each other, storing the search group in a storage including the one or more searches, in response to an update event, initiating a search update on each of the searches under the search group by replaying a search query corresponding to the respective search of the search group, receiving search results in response to the search query, and creating a union of the search results from the search results of the searches under the search group.

Referring to FIG. 9, a user starts by deciding if a new search page is desired (block 301). If it is, a new search page is created (block 302), and this new search page becomes the selected search page. In one embodiment, a new search page may be created by activating an appropriate menu item 279 from the exemplary GUI shown in FIG. 7B. Otherwise, an existing search page is selected (block 303). In one embodiment, a search page may be selected by activating a node corresponding to a search page from the search tree. The user next decides if the search should belong to a search group (block 304).

If the user does not want the search to be grouped, the search page remains selected, and it becomes the parent of the search. Otherwise, the user decides if a new search group is desired (block 305). If so, a search group is created (block 306), for example, by activating an appropriate menu item from the exemplary GUI shown in FIG. 7B. This new search group becomes the selected search group. Otherwise, an existing search group is selected (block 307) by selecting a node corresponding to a search group in the search tree. The selected node in the search tree at this time will be the parent of the new search. A search is created (block 308). The search may be created using similar menu item 277 of exemplary GUI shown in FIG. 7B. If additional searches are needed (block 309), the process can begin again from block 301 to build the search tree.

The search tree is an adaptable structure. The user can save and organize searches for repeatability, and control the layout of the search results. The user is able to see related items in a common context, and they will not see duplicate results if multiple search queries should overlap. Users gain the freedom to search creatively without the shortcomings of the flat interface, and they get are able to search consistently and completely with ease.

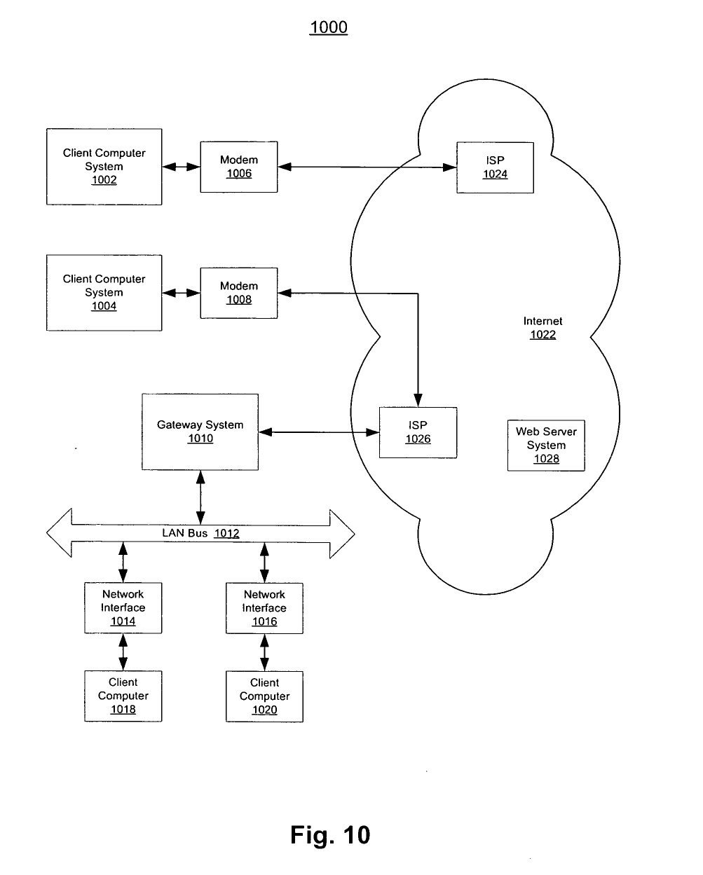

FIG. 10 is a diagram of a network of computer systems may be used with an embodiment of the invention. As shown in FIG. 10, a network 1000 includes a number of client computer systems that are coupled together through an Internet 1022. It will be appreciated that the term “Internet” refers to a network of networks. Such networks may use a variety of protocols for exchange of information, such as TCP/IP, ATM, SNA, SDI, etc. The physical connections of the Internet and the protocols and communication procedures of the Internet are well known to those in the art. It will be also appreciated that such a system may be implemented in an Intranet within an organization.

Access to the Internet 1022 is typically provided by Internet service providers (ISPs), such as the ISP 1024, and the ISP 1026. Users on client systems, such as the client computer systems 1002, 1004, 1018, and 1020, generally obtain access to the Internet through Internet service providers, such as ISPs 1024 and 1026. Access to the Internet may facilitate transfer of information (e.g., email, text files, media files, etc.) between two or more digital processing systems, such as the client computer systems 1002, 1004, 1018, and 1020 and/or a Web server system 1028. For example, one or more of the client computer systems 1002, 1004, 1018, and 1020 and/or the Web server 1028 may provide document presentations (e.g., a Web page) to another one or more of the client computer systems 1002, 1004, 1018, and 1020 and/or Web server 1028. For example, in one embodiment of the invention, one or more client computer systems 1002, 1004, 1018, and 1020 may request to access a document that may be stored at a remote location, such as the Web server 1028. In the case of remote storage, the data may be transferred as a file (e.g., download) and then displayed (e.g., in a window of a browser) after transferring the file. In another embodiment, the document presentation may be stored locally at the client computer systems 1002, 1004, 1018, and/or 1020. In the case of local storage, the client system may retrieve and display the document via an application, such as a word processing application. Without requiring a network connection.

The Web server 1028 typically includes at least one computer system to operate with one or more data communication protocols, such as the protocols of the World Wide Web, and as such, is typically coupled to the Internet 1022. Optionally, the Web server 1028 may be part of an ISP which may provide access to the Internet and/or other network(s) for client computer systems. The client computer systems 1002, 1004, 1018, and 1020 may each, with appropriate Web browsing software, access data, such as HTML document (e.g., Web pages), which may be provided by the Web server 1028.

The ISP 1024 provides Internet connectivity to the client computer system 1002 via a modem interface 1006, which may be considered as part of the client computer system 1002. The client computer systems 1002, 1004, 1018, and 1020 may be a conventional data processing system, such as a Power Mac G5 or iMac computer available from Apple Computer, Inc., an IBM compatible PC, a “network” computer, a handheld/portable computer, a cell phone with data processing capabilities, a Web TV system, or other types of digital processing systems (e.g., a personal digital assistant (PDA)).

Similarly, the ISP 1026 provides Internet connectivity for the client computer systems 1002, 1004, 1018, and 1020. However, as depicted in FIG. 10, such connectivity may vary between various client computer systems, such as the client computer systems 1002, 1004, 1018, and 1020. For example, as shown in FIG. 10, the client computer system 1004 is coupled to the ISP 1026 through a modem interface 1008, while the client computer systems 1018 and 1020 are part of a local area network (LAN). The interfaces 1006 and 1008, shown as modems 1006 and 1008, respectively, may represent an analog modem, an ISDN modem, a DSL modem, a cable modem, a wireless interface, or other interface for coupling a digital processing system, such as a client computer system, to another digital processing system. The client computer systems 1018 and 1020 are coupled to a LAN bus 1012 through network interfaces 1014 and 1016, respectively. The network interface 1014 and 1016 may be an Ethernet-type, asynchronous transfer mode (ATM), or other type of network interface. The LAN bus is also coupled to a gateway system 1010, which may provide firewall and other Internet-related services for a LAN. The gateway digital processing system 1010, in turn, is coupled to the ISP 1026 to provide Internet connectivity to the client computer systems 1018 and 1020. The gateway digital processing system 1010 may, for example, include a conventional server computer system. Similarly, the Web server 1028 may, for example, include a conventional server computer system.

According to one embodiment, Web server 1028 may be an eCommerce Web site, such as, for example, an eBay Web site, hosting an eCommerce activity such as auction activities. The users accessing Web server 1028 may use a search utility having GUIs similar to those illustrated in FIGS. 1-4, 5A-5D, 6, 7A-7B, and 8 described above. The search utility may be executed within the Web server 1028, clients 1002, 1004, 1018, and 1020, or both the clients and the server.

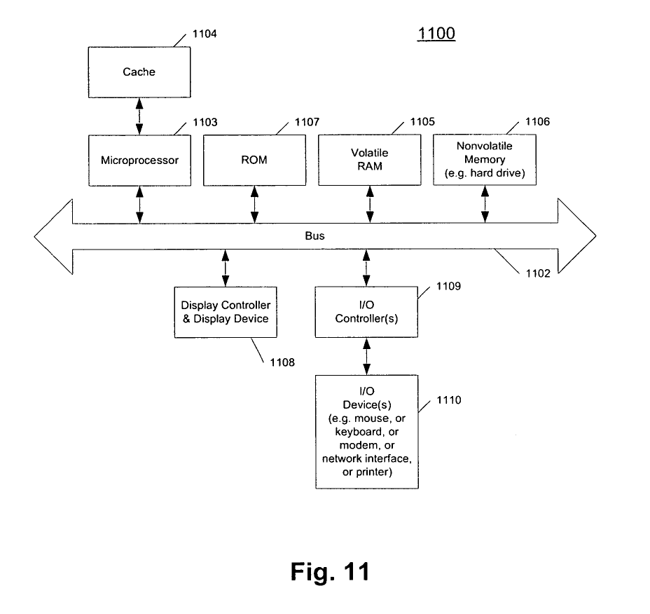

FIG. 111 is a block diagram of a digital processing system which may be used with one embodiment of the invention. For example, the system 1100 shown in FIG. 11 may be used as a client computer system (e.g., the client computer systems 1002, 1004, 1018, and/or 1020 of FIG. 10), a Web server system (e.g., the Web server system 1028), or a conventional server system, etc. Furthermore, the digital processing system 1100 may be used to perform one or more functions of an Internet service provider, such as the ISP 1024 and 1026.

Note that while FIG. 11 illustrates various components of a computer system, it is not intended to represent any particular architecture or manner of interconnecting the components, as such details are not germane to the present invention. It will also be appreciated that network computers, handheld computers, cell phones, and other data processing systems which have fewer components or perhaps more components may also be used with the present invention. The computer system of FIG. 11 may, for example, be an Apple Macintosh computer or a IBM compatible PC.

As shown in FIG. 11, the computer system 1100, which is a form of a data processing system, includes a bus 1102 which is coupled to a microprocessor 1103 and a ROM 1107, a volatile RAM 1105, and a non-volatile memory 1106. The microprocessor 1103, which may be, for example, a PowerPC G4 or PowerPC G5 microprocessor from Motorola, Inc. or IBM, is coupled to cache memory 1104 as shown in the example of Figure 11. The bus 1102 interconnects these various components together and also interconnects these components 1103, 1107, 1105, and 1106 to a display controller and display device 1108, as well as to input/output (I/O) devices 1110, which may be mice, keyboards, modems, network interfaces, printers, and other devices which are well-known in the art. Typically, the input/output devices 1110 are coupled to the system through input/output controllers 1109. The volatile RAM 1105 is typically implemented as dynamic RAM (DRAM) which requires power continuously in order to refresh or maintain the data in the memory. The non-volatile memory 1106 is typically a magnetic hard drive, a magnetic optical drive, an optical drive, or a DVD RAM or other type of memory system which maintains data even after power is removed from the system. Typically the non-volatile memory will also be a random access memory, although this is not required. While FIG. 11 shows that the non-volatile memory is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface. The bus 1102 may include one or more buses connected to each other through various bridges, controllers, and/or adapters, as is well-known in the art. In one embodiment, the I/O controller 709 includes a USB (Universal Serial Bus) adapter for controlling USB peripherals. Alternatively, I/O controller 1109 may include an IEEE-1394 adapter, also known as FireWire adapter, for controlling FireWire devices.

Thus, method and apparatus for organizing searches and controlling the presentation of the search results have been described. In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A process for organizing searches, retrieving search results, and controlling the presentation of search results in a computer environment, the process comprising:
creating a search group;
creating a search as a child of the search group; and
an update event,
wherein the search group can parent one or more searches,
wherein the search stores a search query,
wherein the update event includes at least one of a timed interval, upon demand, or a combination of the above,
wherein upon occurrence of the update event, a search update begins,
wherein the search update on the search group initiates search updates on all searches parented by the search group,
wherein the search update on the search replays the stored search query and retrieves search results,
wherein the search update on the search group completes when the search updates on the search group's child searches are complete,
wherein upon completion of search update for the search group, a union of search results is created from the search results of the search group's child searches,
wherein a user is able to save and organize searches, and
wherein a user is able to replay saved and organized searches.

2. The process of claim 1, further comprising:
creating a search page,
wherein the search page is a parent of one or more searches and/or search groups;
wherein upon occurrence of the update event, initiates search updates on all its child nodes,
wherein upon completion of search updates on the child nodes, the search results are arranged in the order that matches the order of the children, and
wherein a user is able to control the order of the search results.

3. The process of claim 1, wherein creation of the search group allows the attachment of search group attributes to the search group,
wherein the search group attributes include at least one of a name, notes, highlighting, update event interval, email notification, alerts, or a combination of the above,
wherein a user is able to attach information to the search group to help with search organization,
wherein a user is able to attach information to the union of search results to help with finding items of interest,
wherein a user is able to specify automated occurrences of the update events, and
wherein a user is able to specify alerts and notifications to be informed of when items are found.

4. The process of claim 1, wherein creation of the search group allows the attachment of search group restrictions to the union of the search results,
wherein the search group restrictions include at least one of a search result sort order, search result attributes, notes, highlighting, or a combination of the above,
wherein the search result attributes include at least one of a minimum price, maximum price, minimum bids, maximum bids, picture presence, date listed, date ending, item category, item location, item currency, seller properties, or a combination of the above,
wherein the seller properties include at least one of seller location, seller rating, or a combination of the above, and
wherein a user is able to filter the union of the search results of the search group.

5. The process of claim 1, wherein creation of the search allows the attachment of search attributes to the search,
wherein the search attributes include at least one of a name, notes, highlighting, email notification, alerts, or a combination of the above,
wherein a user is able to attach information to the search to help with search organization,
wherein a user is able to attach information to the search results to help with finding items of interest, and
wherein a user is able to specify alerts and notifications to be informed of when items are found.

6. The process of claim 1, wherein creation of the search allows the attachment of search restrictions to the search results,
wherein the search restrictions include at least one of a search result sort order, search result attributes, notes, highlighting, or a combination of the above,
wherein the search result attributes include at least one of a minimum price, maximum price, minimum bids, maximum bids, picture presence, date listed, date ending, item category, item location, item currency, seller properties, or a combination of the above,
wherein the seller properties include at least one of a seller location, seller rating, or a combination of the above, and
wherein a user is able to filter search results of the search.

7. The process of claim 1, further comprising:
attaching the update event to a node in the hierarchy, by means of attaching including at least one of a textual reference, clicking on a user-interface button, clicking on a link, a menu selection, or a combination of the above,
wherein the update event initiates a search update on the node, and
wherein a user is able to initiate a search update on a subset of the hierarchy.

8. The process of claim 1, wherein the search stores an auction search query.

9. The process of claim 1, wherein implementation of the elements of the process is selected from the group consisting of: entirely on a client system, divided between a client and a plurality of server systems, and entirely on a plurality of server systems.

10. An apparatus for organizing searches, retrieving search results, and controlling the presentation of search results in a computer environment, comprising:
a module for creating a search group;
a module for creating a search as a child of the search group; and
a module for initiating an update event,
wherein the search group creation module allows the attaching of one or more searches,
wherein the search creation module attaches a search query,
wherein the update event initiating module indicates how often and/or when a search update will begin,
wherein the search update on the search group begins a search update on all searches parented by the search group,
wherein the search update on the search replays the stored search query and retrieves search results,
wherein the search update for the search group creates a union of search results from the search results of the search group's child searches,
wherein a user is able to save and organize searches, and
wherein a user is able to replay saved and organized searches.

11. The apparatus of claim 10, further comprising:
a module for creating a search page,
wherein the search page creation module allows the attachment of one or more searches and/or search groups,
wherein the update event begins a search update on all its child nodes,
wherein the search results are arranged in the order that matches the order of the children, and
wherein a user is able to control the order of the search results.

12. The apparatus of claim 10, wherein the search group creation module allows the attachment of search group attributes to the search group,
wherein the search group attributes include at least one of a name, notes, highlighting, update event interval, email notification, alerts, or a combination of the above,
wherein a user is able to attach information to the search group to help with search organization,
wherein a user is able to attach information to the union of search results to help with finding items of interest,
wherein a user is able to specify automated occurrences of the update events, and
wherein a user is able to specify alerts and notifications to be informed of when items are found.

13. The apparatus of claim 10, wherein creation module of the search group allows the attachment of search group restrictions to the union of the search results,
wherein the search group restrictions include at least one of a search result sort order, search result attributes, notes, highlighting, or a combination of the above,
wherein the search result attributes include at least one of a minimum price, maximum price, minimum bids, maximum bids, picture presence, date listed, date ending, item category, item location, item currency, seller properties, or a combination of the above,
wherein the seller properties include at least one of a seller location, seller rating, or a combination of the above.

14. The apparatus of claim 10, wherein creation module of the search allows the attachment of search attributes to the search,
wherein the search attributes include at least one of a name, notes, highlighting, email notification, alerts, or a combination of the above,
wherein a user is able to attach information to the search to help with search organization,
wherein a user is able to attach information to the search results to help with finding items of interest, and
wherein a user is able to specify alerts and notifications to be informed of when items are found.

15. The apparatus of claim 10, wherein creation module of the search allows the attachment of search restrictions to the search results,
wherein the search restrictions include at least one of a search result sort order, search result attributes, notes, highlighting, or a combination of the above,
wherein the search result attributes include at least one of a minimum price, maximum price, minimum bids, maximum bids, picture presence, date listed, date ending, item category, item location, item currency, seller properties, or a combination of the above;
wherein the seller properties include at least one of a seller location, seller rating, or a combination of the above, and
wherein a user is able to filter search results of the search.

16. The apparatus of claim 10, further comprising:
associating the update event to a node in the hierarchy, by means of association including at least one of a textual reference, clicking on a user-interface button, clicking on a link, a context menu, selection of the node followed by a menu selection, or a combination of the above,
wherein the search update event begins on the node.

17. The apparatus of claim 10, wherein the search creation module attaches an auction search query.

18. The apparatus of claim 10, wherein implementation of the elements of the apparatus is selected from the group consisting of: entirely on a client system, divided between a client and a plurality of server systems, and entirely on a plurality of server systems.
